(19) United States
(12) Patent Application Publication
(10) Pub. No.: US 2011/0104439 A1
(43) Pub. Date: May 5, 2011

(54) TRANSPARENT WATER-REPELLENT GLASS AND METHOD OF MANUFACTURE THEREOF

(76) Inventors: Hyeon Choi, Daejeon Metropolitan City (KR); Jee-Seon Kim, Seoul (KR); Jea-Jin Kim, Songpa-gu (KR); Young-Jun Hong, Daejeon Metropolitan City (KR); Bu-Gon Shin, Daejeon Metropolitan City (KR); Tae-Su Kim, Daejeon Metropolitan City (KR)

(21) Appl. No.: 13/002,447

(22) PCT Filed: Jul. 3, 2009
(86) PCT No.: PCT/KR2009/003657

§ 371 Date: Jan. 3, 2011

(30) Foreign Application Priority Data
Jul. 4, 2008 (KR) 10-2008-0064895

(51) Int. Cl. B32B 17/06; B32B 3/26; B32B 7/02; C03C 15/00

(52) U.S. Cl. 428/142; 428/161; 216/37

(57) ABSTRACT

The present invention relates to water-repellent glass including: glass including pores formed to have a diameter of 200 nm or less on a surface; and a water-repellent coating layer disposed at least on one side of the glass, and a method of manufacturing the water-repellent glass.

### TECHNICAL FIELD

The present invention relates to water-repellent glass and a method of manufacturing the same. More particularly, the present invention relates to high-transparent and water-repellent glass and a method of manufacturing the same.

This application claims priority from Korean Patent Application No. 2008-0064895 filed on Jul. 4, 2008 in the Korean Intellectual Property Office (KIPO), the disclosure of which is incorporated herein by reference in its entirety.

### BACKGROUND ART

The contact angle of the surface is not more than 120 degrees, when glass with a flat surface is coated with a water-repellent substance. However, the contact angle of the surface may become 120 degrees or more, when the roughness of the glass surface is adjusted. In particular, as can be seen from the lotus effect, when the glass surface is given nano-scaled and micron-scaled roughness, the contact angle of the surface is over 150 degrees and a self-cleaning effect can be achieved by low surface energy. However, the glass having given the roughness, as described above, becomes opaque or blurred by dispersion of the visible light due to the nano-scaled and micro-scaled structure, such that it cannot be used as glass requiring transparency.

Therefore, a technology of achieving a contact angle of the surface over 120 degrees by adjusting the roughness after disposing an inorganic layer on the glass surface has been developed. The technology, however, is disadvantageous in abrasion resistance, when contact is repeated.

Accordingly, it is required to develop water-repellent glass with high abrasion resistance and high transparency as well as water repellency to be used as glass requiring transparency and repeated contact, such as glass for vehicles, glass for buildings, and mirrors.

### DISCLOSURE

### Technical Problem

The present invention has been made in an effort to provide water-repellent glass having high water repellency and transparency and a method of manufacturing the water-repellent glass.

### Technical Solution

An aspect of the present invention provides water-repellent glass including: glass including pores formed to have a diameter of 200 nm or less on a surface; and a water-repellent coating layer disposed at least on one side of the glass.

Another aspect of the present invention provides a method of manufacturing water-repellent glass, which includes: forming pores having a diameter of 200 nm or less on a surface of glass; and forming a water-repellent coating layer at least on one side of the glass where the pores are formed.

### Advantageous Effects

According to the present invention, it is possible to considerably increase water repellency without reducing transparency by minimizing dispersion of the visible light, by forming a structure having a diameter of 200 nm or less before forming a water-repellent coating layer on a surface of glass.

### DESCRIPTION OF DRAWINGS

FIG. 1 is a cross-sectional view showing an example of water-repellent glass according to the present invention.

### BEST MODE

Water-repellent glass according to the present invention includes glass including pores formed on a surface and having a diameter of 200 nm or less and a water-repellent coated layer on at least one side of the glass. In detail, the water-repellent glass according to the present invention is manufactured by forming the pores having a diameter of 200 nm or less and further forming the water-repellent coated layer on the surface of the glass, unlike the prior art in which only a water-repellent coated layer is formed to provide water repellency or nano-scaled and micro-scaled surface roughness is implemented to provide water repellency.

The pores on the glass surface increase the contact angle of the surface by holding an air layer having the highest water repellency. Meanwhile, the visible light has a wavelength of 400 to 800 nm. It is possible to prevent the visible light from recognizing the pore structure on the glass surface by making the size of the pores on the glass surface 200 nm or less, and accordingly, it is possible to minimize reduction of transparency due to dispersion of the visible light, in the present invention. Therefore, it is possible to greatly improve water-repellency without reducing transparency by the pore structure and the water-repellent coating layer on the glass surface in the present invention.

The transparency of the water-repellent glass according to the present invention may reach 70% or more. Further, the water-repellent glass according to the present invention may have a surface contact angle of up to 120 degrees or more, preferably, up to 150 degrees or more. For example, the contact angle of the surface may be 120 degrees to 170 degrees, but is not limited thereto.

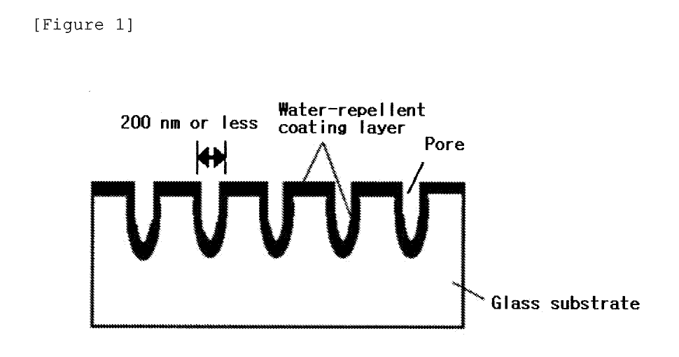

The diameters of the pores on the glass surface are 200 nm or less in the present invention (see FIG. 1). It is possible to improve water repellency without reducing transparency, as described above, when the diameters of the pores are 200 nm or less. The diameters of the pores are preferably 10 nm to 200 nm, and more preferably, 50 nm to 150 nm.

It is preferable that the ratio of diameter to depth of the pore, that is, the aspect ratio is 0.5 to 2. As described above, the pores increase the contact angle of the surface by holding an air layer having the highest water repellency. The increase of a surface contact angle is limited because the entire area of the glass surface is wet before the air layer is formed, when the aspect ratio of the pore is less than 0.5. Further, considering amorphousness of glass, it is advantageous in a process to manufacturing a product having an aspect ratio of 2 or less. The shape of the pore is not specifically limited and may depend on the manufacturing methods, for example, a bar shape or a semispherical shape.

It is preferable that the distance between the pores on the glass surface is 1.5 to 2 times the diameter of the pore when being measured on the glass surface. It is possible to minimize dispersion of the visible light by making the distance between the pores the half-wavelength of 400 nm or less, which is the shortest wavelength of the visible light.

The shape, size, and distribution of the pores on the glass surface may be uniform or may not be uniform. When the pores have a uniform structure, uniform water repellency can be maintained throughout the area where the pore structure is formed, such that it is possible to preclude the possibility that water drops form and collect where the water repellency is relatively low. However, a process that satisfies the condition structurally requires high accuracy, such that a non-uniform pattern has an advantage of reducing the manufacturing cost. Further, when the present invention is applied to the glasses of vehicles that travel, it is possible to ensure high visibility in a rain only by ensuring water repellency of 120 degrees or more, because water drops on the glasses can be blown out by the wind hitting against the glasses. The non uniform structure implies that structural regularity is not necessary, that is, the distance between the pores and the radii of the pores are not necessarily completely regular.

The water-repellent coating layer may be made of water-repellent coating material known in the art, in the present invention. Hydrocarbon-based compounds, silicon-based compounds, chlorine-based compounds, and fluorine-based compounds etc. may be used as the water coating material in the present invention.

The fluorine-based compounds are, for example, an oligomer type having a molecular weight of 1000 to 1500, and preferably contains perfluoro silane. It is the most preferable to use FAS (Fluoroalkylsilane)-based substances, but the scope of the present invention is not limited thereto.

The water-repellent coating layer is disposed on a side of the glass where the pores are formed, and may be disposed on both the surface of the glass and the inner sides of the pores. That is, the water-repellent coating layer may be disposed throughout one side of the glass.

When the water-repellent coating layer is too thick, the coating layer is formed too thick in the pores, such that the air layer that is supposed to be formed therein may be reduced. Therefore, the thickness of the water-repellent coating layer is preferably 20 nm or less (see FIG. 1), more preferably 1 nm to 20 nm, and more preferably 1 nm to 10 nm.

Meanwhile, the present invention provides a method of manufacturing water-repellent glass. A manufacturing method according to the present invention includes first forming pores having a diameter of 200 nm or less on a surface of glass. This step can be used without a limit as long as it can form pores having a diameter of 200 nm or less on the glass surface. The forming of pores may include forming a pore pattern on the glass surface and etching the glass.

When only a portion of the glass surface is etched, as shown in FIG. 1, the non-etched portion can maintain flatness of the glass, such that abrasion resistance can be improved. Further, since the water-repellent coating layer in the pores can be protected from continuous contact and the air layer in the pores can be kept, the water repellency can be kept. Therefore, the abrasion resistance can be improved.

The forming of a pore pattern on the glass surface can be performed as follows. According to an example, it is possible to form a pore pattern using interference photolithography, manufacture a mold using the pore pattern, and form an inverse pattern of the desired pore pattern on the glass surface in a roll-printing method using the mold. The material of the mold may be PDMS. As a more detailed example, a method of forming a pore pattern using laser interference exposure is as follows. The method is to split a laser beam into two beams with a beam splitter, enlarge the beams with a lens, and radiate the beam to overlap each other on a sample coated with a photosensitizer, in which a grid pattern having a pitch smaller than the laser wavelength can be achieved and a nano-sized post pattern can be achieved by rotating the sample at 90° for two-times exposure after interference exposure. According to another example, it is possible to form an inverse pattern of a pore pattern on the glass surface by mixing a nano-sphere having a diameter of 200 nm or less with a polymer, coating the mixture on the glass, and removing any one of the nano-sphere and the polymer by dissolving or etching.

According to another example, it is possible to form an inverse pattern of a pore having a diameter of 200 nm or less, using phase-separation of a copolymer.

Etching the glass may be performed by methods known in the art. For example, it is possible to etch the glass with an etching solution containing HF or ammonium bifluoride(NH₄HF₂). In this process, the glass may be dipped in the etching solution or the etching solution may be sprayed onto the glass. Further, the glass may be plasma-etched by a gas containing fluorine (F).

A water-repellent coating layer is formed on at least one side of the glass after the pores having a diameter of 200 nm or less is formed on the surface of the glass. The thickness of the water coating layer may be 20 nm or less, preferably 1 nm to 20 nm, and more preferably 1 nm to 10 nm.

Materials known in the art may be used to form the water-repellent coating layer, and a composite additionally containing a solvent or an additive, if needed, may be used to provide the water-repellent coating material with coating performance.

It is preferable to use a method that expose the structure of the pore having a diameter of 200 nm or less on the surface of the water-repellent glass even after forming the water-repellent coating layer, without largely deforming the pore structure on the glass surface.

For example, it is possible to form the water-repellent coating layer by wet etching, using a water-repellent coating composition in which the concentration of a solid is 1 wt % or less, preferably 0.1 wt % or less, or by dry coating, such as vapor deposition.

The water-repellent glass according to the present invention can be used for any cases requiring transparency and water repellency, without a limit in use. For example, the water-repellent glass may be used for the glasses of vehicles, the glasses of buildings, and mirrors etc.

### MODE FOR INVENTION

### Example 1

A mold for forming a pore pattern was manufactured, using laser interference exposure. In detail, a photosensitive pattern was formed in a post type having a pitch of 190 nm and a diameter of 100 nm by rotating a photosensitive sample by 90° for each time to perform exposure twice, using Nd-YAG 4^{th} harmonic laser (266 nm). A mold having an inverse pattern was manufactured by using the photosensitive pattern formed as described above. A release compound was coated on the surface with the pattern of the manufactured mold and a pattern blanket with a pattern transcribed from the mold was made by casting a silane-based elastomer. An inverse pattern of desired pores having a diameter of 100 nm was formed on the glass surface by a roll printing method using the pattern blanket. A pore pattern was formed in a post type having a diameter of about 100 nm on the glass surface with the printed inverse pattern of the pores, by dipping the glass in an HF solution. The depth of the pores is 100 nm and the aspect ratio is 1. A water-repellent coating layer having a thickness of about 10 nm was formed by spin-coating a water-repellent solution onto the glass surface with the pores. The water-repellent solution was a substance made by diluting DSX by DAIKIN with a perfluoro solvent (product name: FC 3283) of 1 wt %

Water repellency was evaluated by measuring a surface contact angle of a 3 μm water drop. The contact angle of the glass was about 144±1°. The average transmittance of the same was 80% in the visible light region and did not have a specific color.

### Example 2

Water-repellent glass was manufactured in the same method as Example 1, except that the depth of pores was 60 nm and the aspect ratio of the pores was 0.6. The contact angle of the surface was about 122±2°. The average transmittance of the same was 80% in the visible light region and did not have a specific color.

### Comparative Example 1

Water-repellent glass was manufactured in the same method as Example 1, except that pores were not formed on the glass surface. The contact angle of the surface was about 113±0.9°.

### Comparative Example 2

Water-repellent glass was manufactured in the same method as Example 1, except that a water-repellent coating layer was not formed on the glass surface. The contact angle of the surface was about 4 to 5°.

As a result, it could be seen that a surface contact angle of 120 degrees or more was achieved, the average transmittance was 80% in the visible light region, and a specific color was not shown, unlike Comparative Examples 1 and 2 in which the contact angle of the surface was less than 120 degrees, in Examples 1 and 2 of the present invention in which the pores were formed on the glass surface and the water-repellent coating layer was formed on the surface.

1. Water-repellent glass comprising:
glass including pores formed to have a diameter of 200 nm or less on a surface; and
a water-repellent coating layer disposed at least on one side of the glass.

2. The water-repellent glass according to claim 1, wherein transparency is 70% or more.

3. The water-repellent glass according to claim 1, wherein a contact angle of the surface is 120 degrees or more.

4. The water-repellent glass according to claim 1, wherein the aspect ratio of the pore is 0.5 to 2.

5. The water-repellent glass according to claim 1, wherein the shape of the pore is a bar or a semi-sphere.

6. The water-repellent glass according to claim 1, wherein the distance between the pores on the glass surface is 1.5 to 2 times the diameter of the pores when being measured on the glass surface.

7. The water-repellent glass according to claim 1, wherein the shape, size, or distribution of the pores on the glass surface is uniform or non-uniform.

8. The water-repellent glass according to claim 1, wherein the thickness of the water-repellent coating layer is 20 nm or less.

9. A method of manufacturing water-repellent glass, comprising:
forming pores having a diameter of 200 nm or less on a surface of glass; and
forming a water-repellent coating layer at least on one side of the glass where the pores are formed.

10. The method of manufacturing water-repellent glass according to claim 9, wherein the forming of pores having a diameter of 200 nm or less on a surface of glass includes forming a pore pattern on the glass surface and etching the glass.

11. The method of manufacturing water-repellent glass according to claim 9, wherein the forming of a water-repellent coating layer is performed by wet coating or dry coating, using a composition for forming a water-repellent coating layer which contains a solid having a concentration of 1 wt % or less.

12. The method of manufacturing water-repellent glass according to claim 9, wherein the water-repellent coating layer is formed to have a thickness of 20 nm or less in the forming a water-repellent coating layer.
